(19) United States
(12) Patent Application Publication
(10) Pub. No.: US 2014/0160957 A1
(43) Pub. Date: Jun. 12, 2014

(54) CHANNEL STATE INFORMATION CALIBRATION

(71) Applicant: BROADCOM CORPORATION, Irvine, CA (US)

(72) Inventors: Jun Zheng, San Diego, CA (US); Nihar Jindal, San Mateo, CA (US); Sirikiat Ariyavisitakul, Alpharetta, GA (US); Eric Ojard, San Francisco, CA (US)

(73) Assignee: BROADCOM CORPORATION, Irvine, CA (US)

(21) Appl. No.: 13/730,771

(22) Filed: Dec. 28, 2012

Related U.S. Application Data
(60) Provisional application No. 61/735,939, filed on Dec. 11, 2012.

(51) Int. Cl. H04W 24/02

(52) U.S. Cl. CPC H04W 24/02
USPC 370/252

(57) ABSTRACT

A dedicated calibration device may be utilized by a wireless transceiver device, such as a base station, to compute compensation matrices. The wireless transceiver device and the dedicated calibration device can exchange training sequence signals. Based on the exchanged training sequence signals, the wireless transceiver device and the dedicated calibration device can estimate overall baseband to baseband channel responses taking into account the amplitude and phase responses of the respective transmit and receive radio chains, and the wireless transceiver device can determine the compensation matrices. Furthermore, the wireless transceiver device can estimate a baseband-to-baseband uplink channel response relative to actual user equipment, approximate a downlink channel response using only one of the determined compensation matrices, and perform beamforming to the actual user equipment using the approximated downlink channel response.

### TECHNICAL FIELD

The technical field of the present disclosure relates to wireless communication systems, and more particularly, to utilizing a dedicated calibration device to approximate a downlink (DL) propagation channel, thereby allowing transmit beamforming in wireless communications, such as “massive” Multiple Input Multiple Output (MIMO), to be performed by a base station (BS).

### BACKGROUND

Communication systems may support wireless and wireline communications between wireless and/or wireline communication devices. Each type of communication system may be constructed/configured to operate in accordance with one or more communication standards. For instance, wireless communication systems may operate in accordance with one or more standards including, but not limited to, Radio Frequency Identification (RFID), Institute of Electrical and Electronic Engineers (IEEE) 802.11, Bluetooth®, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

A wireless communication device, such as a cellular telephone, two-way radio, personal digital assistant (PDA), personal computer (PC), laptop computer, home entertainment equipment, radio frequency identification (RFID) reader, RFID tag, etc. may communicate directly or indirectly with other wireless communication devices. For direct communications (also known as point-to-point communications), the participating wireless communication devices may tune their receivers and transmitters to the same channel(s) (e.g., one of the plurality of RF carriers of a wireless communication system or a particular RF frequency for some systems) and communicate over that channel(s). For indirect wireless communications, a wireless communication device may communicate directly with an associated BS (e.g., for cellular services) and/or an associated access point (AP) (e.g., for an in-home or in-building wireless network) via an assigned channel. The BS/AP may then relay the communication to another wireless communication device either directly or through additional base stations/access points, etc. To complete a communication connection between the wireless communication devices, the associated BSs and/or associated APs may communicate with each other directly, via a system controller, the public switch telephone network, the Internet, and/or some other wide area network.

To participate in wireless communications, each wireless communication device may include a built-in radio transceiver (i.e., receiver and transmitter), or may be coupled to an associated radio transceiver (e.g., a station for in-home and/or in-building wireless communication networks, RF modem, etc.). In most applications, radio transceivers are implemented in one or more integrated circuits (ICs), which can be inter-coupled via traces on a printed circuit board (PCB).

A transmitter aspect of the radio transceiver can include a data modulation stage, one or more intermediate frequency (IF) stages, and a power amplifier (PA). The data modulation stage can be configured to convert raw data into baseband signals in accordance with a particular wireless communication standard. The one or more intermediate frequency stages can be configured to mix the baseband signals with one or more local oscillations to produce RF signals. The PA can be configured to amplify the RF signals prior to transmission via an antenna.

A receiver aspect of the radio transceiver can be coupled to the antenna through an antenna interface and can include a low noise amplifier (LNA), one or more intermediate frequency stages, a filtering stage, and a data recovery stage. The LNA can be configured to receive inbound RF signals via the antenna and amplify them. The one or more IF stages can be configured to mix the amplified RF signals with one or more local oscillations to convert the amplified RF signal into baseband signals or IF signals. The filtering stage can be configured to filter the baseband signals or the IF signals to attenuate unwanted, out-of-band signals to produce filtered signals. The data recovery stage can then recover raw data from the filtered signals in accordance with the particular wireless communication standard.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram representative of an example transceiver device in accordance with various embodiments of the present disclosure;

FIG. 2 illustrates example instantiations of a calibration device utilized in accordance with various embodiments of the present disclosure;

FIG. 3 illustrates an example system model representative of baseband-to-baseband channel response in accordance with various embodiments of the present disclosure;

FIG. 4 illustrates an example reciprocity compensation model representative of the introduction of compensation matrices in accordance with various embodiments of the present disclosure; and

FIG. 5 is a flow chart illustrating example processes performed for calibration and beamforming in accordance with various embodiments of the present disclosure.

### DETAILED DESCRIPTION

Radio spectrum may be organized (and often) sold/auctioned as paired spectrum, where paired spectrum can refer to a block of the radio spectrum in a lower frequency band and an associated block of radio spectrum in an upper frequency band. This arrangement of frequency bands, i.e., pairs of frequency bands, allows one frequency band to be used for uplink (UL) communications, and one frequency band to be used for DL communications—hence the term “paired spectrum.” In particular, and in a frequency block, a number of frequency channels may be paired with associated frequency channels in another frequency block, where one frequency channel may transmit in one direction (e.g., downstream from a base station (BS) to a wireless communication device, also known as user equipment (UE), i.e., the DL channel). A second frequency channel may operate in the opposite direction (e.g., upstream from the UE to the BS, i.e., the UL channel). This pair of frequency channels may be separated by a duplex distance to isolate signals on the DL and UL channels.

As a result of the diminishing availability of paired spectrum, a technique referred to as Time Division Duplex (TDD) may be used. In TDD, the UL and DL utilize the same frequency, where the UL and DL traffic are separated in time. That is, users may be assigned one or more time slots assigned for the UL and DL, respectively, making it possible to dynamically allocate more bandwidth to, e.g., downstream traffic if need be. In a TDD system, and as will be described in greater detail below, the UL and DL channels may be thought of as being reciprocal.

Long Term Evolution (LTE), a new generation radio interface promulgated by the 3^{rd} Generation Partnership Project (3GPP), may refer to a follow up and evolution of the 3GPP air interface, known as Universal Mobile Telecommunications System (UMTS) (evolved UMTS Terrestrial Radio Access (UTRA)), and its associated radio access network, known as the UMTS Terrestrial Radio Access Network (UTRAN). LTE can be associated with higher peak data rates with reduced latency, and may improve spectral efficiency. LTE may utilize Orthogonal Frequency Division Multiplexing (OFDM) on the DL to handle multipath routing and allow for scalable bandwidths. The UL can use a single carrier combined with Frequency Division Multiple Access (FDMA) technology to allow for power-efficient transmission of the UE, where bandwidth is variable to accommodate different data rates, and where users are separated through the use of a unique time interval on an assigned frequency. Frequency separation may also be utilized if, e.g., a UE has limited transmission power/insufficient data to transmit.

Multiple input multiple output (MIMO) systems can refer to wireless communications systems specified in the IEEE 802.11 standard, where a MIMO system that receives a signal may compute a channel estimate matrix, H, based on the received signal. The signal may comprise information generated from a plurality of information sources. Each such information source may be referred to as a spatial stream. A transmitter within the MIMO system may utilize a plurality of transmitting antennas when transmitting the signal, while a receiver within the MIMO system may utilize a plurality of receiving antennas when receiving the signal.

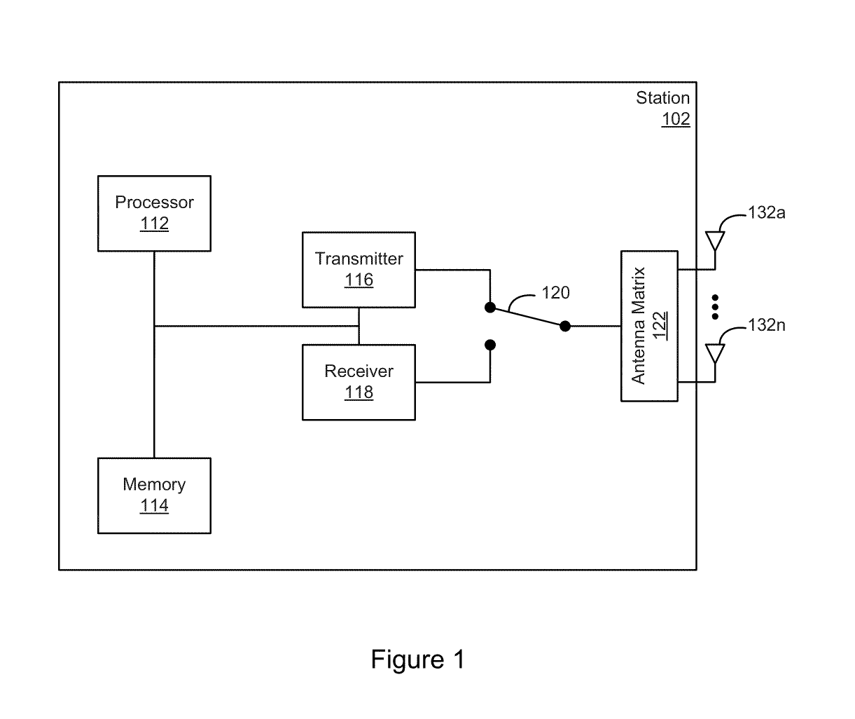

FIG. 1 is a block diagram of an example transceiver device, such as a MIMO transceiver, which may be utilized in connection with various embodiments of the present disclosure. Referring to FIG. 1, a wireless transceiver station 102 and a plurality of antennas 132a . . . 132n are shown. The example wireless transceiver station 102 may include a processor 112, a memory 114, a transmitter 116, a receiver 118, a transmit and receive (T/R) switch 120 and an antenna matrix 122 to which the plurality of antennas 132a . . . 132n are connected.

The wireless transceiver station 102 and its components may comprise suitable logic, circuitry, interfaces and/or code that may be operable to perform at the least the functions, operations and/or methods described herein. The wireless transceiver station 102 may be utilized at a BS or at a UE in a wireless communication system. In an exemplary 3GPP wireless communication system, the BS may be referred to as a node B (NB) (eNB in LTE). In an example MIMO communication system, the BS may be referred to as an access point (AP). The UE may be referred to as a station (STA). An AP and/or STA may be utilized in wireless local area network (WLAN) systems.

The plurality of antennas 132a . . . 132n may enable the wireless transceiver station 102 to transmit and/or receive signals, for example RF signals, via a wireless communication medium. The wireless transceiver station 102 may also be depicted as comprising one or more transmitting antennas, which are coupled to the transmitter 116 and one or more receiving antennas, which may be coupled to the receiver 118 without loss of generality. The antenna matrix 122 may enable selection of one or more of the antennas 132a . . . 132n for transmitting and/or receiving signals at the wireless transceiver station 102. The T/R switch 120 may enable the antenna matrix 122 to be communicatively coupled to the transmitter 116 or receiver 118. When the T/R switch 120 enables communicative coupling between the transmitter 116 and the antenna matrix 122, the selected antennas 132a . . . 132n may be utilized for transmitting signals. When the T/R switch 120 enables communicative coupling between the receiver 118 and the antenna matrix 122, the selected antennas 132a . . . 132n may be utilized for receiving signals.

The transmitter 116 may enable the generation of signals, which may be transmitted via the selected antennas 132a . . . 132n. The transmitter 116 may generate signals by performing coding functions, signal modulation and/or signal modulation. In accordance with various embodiments of the present disclosure, the transmitter 116 may enable generation of signals using precoding and/or beamforming techniques.

As utilized herein, the term beamforming may refer generally to a method of signal processing that may allow a transmitting MIMO system, for example, to combine a plurality of spatial streams in a transmitted signal. Beamforming may also refer to a method for signal processing that may allow a receiving MIMO system to separate individual spatial streams in a received signal. That is, and with knowledge of channel state information (CSI) which will be described in greater detail below, a BS can transmit signals from multiple antennas and have the transmission coherently combine at the UE.

The receiver 118 may enable the processing of signals received via the selected antennas 132a . . . 132n. The receiver 118 may generate data based on the received signals by performing signal amplification, signal demodulation and/or decoding functions. In accordance with various embodiments of the present disclosure, the receiver 118 may enable generation of data, which may be utilized by the transmitter 116 for precoding and/or beamforming of generated signals, as previously described.

The processor 112 may enable the generation of transmitted data and/or the processing of received data. The processor 112 may generate data, which is utilized by the transmitter 116 to generate signals. The processor 112 may further process data generated by the receiver 118. In accordance with various embodiments of the present disclosure, and in an NB/eNB, for example, the processor 112 may process data received by the receiver 118 and generate coefficient data, which may be utilized by the transmitter 116 for precoding and/or beamforming of generated signals. The coefficient data may be stored in the memory 114.

In a UE/STA, the processor 112 may be operable to process data received by the receiver to generate beamforming data and/or CSI. The beamforming data and/or CSI may be stored in the memory 114. The beamforming data and/or CSI may also be sent to the transmitter 116 by the processor 112 or may be retrieved from the memory 114 by the transmitter 116. The transmitter 116 may utilize the beamforming data and/or CSI to generate signals, which are transmitted via the transmitting antennas 132a . . . 132n.

A channel estimate matrix for a DL RF channel may be used to describe a characteristic of the wireless transmission medium in the transmission path from the transmitter to the receiver. The channel estimate for an UL RF channel may describe a characteristic of the wireless transmission medium in the transmission path from the receiver to the transmitter. That is, CSI may refer to known channel properties of a communication link. Such information may describe how a signal propagates from the transmitter to the receiver, and may represent the effects of, e.g., scattering, fading, and power decay with distance. Use of CSI can allow the transmitter to adapt its transmissions to current channel conditions, thereby achieving, e.g., more reliable communication, higher data rates, etc. in wireless communication systems in which multi-antenna devices are communicating. In general, CSI may be estimated at the receiver, quantized, and fed back to the transmitter (or alternatively in TDD systems, CSI may be estimated using reverse-link estimation).

According to the principle of reciprocity, and due to certain fundamental laws of physics, a characteristic of wireless transmission mediums in the transmission path from the transmitter to the receiver may be assumed to be identical to a corresponding characteristic of the wireless transmission medium in the transmission path from the receiver to the transmitter. That is, reciprocity (or channel reciprocity) may refer to the premise that physical propagation channels from a BS to a UE and from a UE to a BS are identical. Accordingly, if the BS to UE and the UE to BS links/radio chains operate on the same frequency, as is the case in TDD systems, the propagation channels affecting transmissions in either direction (i.e., DL channel in the case of BS to UE transmissions, or UL channel in the case of UE to BS transmissions) may be the same.

However, the “channel” seen by any wireless transmission may refer not only to the propagation channels, but may also include any digital and/or analog circuitry of the transmitter, as well as any digital and/or analog circuitry of the receiver. Hence, the channel seen by a wireless transmission may in actuality include the physical propagation channel as well as at least some of the circuitry of the transmitter and the receiver. As a result, minute differences in the length of some electrical traces from the digital and analog circuitry to antennas of the transmitter and receiver can become a significant factor, and it may be virtually assured that these differences can differ from device to device. Accordingly, the channel estimate matrix H of the DL RF channel (H_{down}) may not be equal to a corresponding channel estimate matrix H for an uplink RF channel (Hᵤₚ).

Furthermore, noise level, e.g., ambient noise level, in the vicinity of the transmitter may differ from a noise level in the vicinity of the receiver. Similarly, an interference level, for example electro-magnetic interference due to other electro-magnetic devices, in the vicinity of the transmitter may differ from an interference level in the vicinity of the receiver. At a transmitter or receiver, there may also be electrical cross-coupling, for example leakage currents, between circuitry associated with a receiving antenna, a transmitting antenna, and/or circuitry associated with another receiving antenna or another transmitting antenna.

Therefore, and as will be described in greater detail below, an “effective” DL channel for BS to UE traffic, may refer to the following:
BS TX circuitry→Physical propagation channel→UE RX circuitry

An “effective” UL channel for UE to BS traffic may refer to the following:
UE TX circuitry→Physical propagation channel→UE RX circuitry

Assuming that a cellular BS, for example, has multiple antennas with which to communicate with one or more UEs, such, as a cellular telephone(s) that utilizes one or more antennas, if the BS can determine the instantaneous propagation channel (e.g., CSI of the instantaneous propagation channel) to one or more UEs, DL beamforming can be performed to improve the performance of the DL from the BS to the one or more UEs. For example, and in a MIMO OFDM wireless communication system, such as LTE, a propagation channel may refer to the baseband channel response (i.e., a complex number in mathematical terms) associated with each subcarrier for every BS antenna/UE antenna pair (also referred to as “per-UE”), where the propagation channel may be time-varying. The rate of change may depend on a variety of factors, e.g., a UE's velocity, as well as the UE's carrier frequency.

As described previously, beamforming may refer to a method or technique of combining a plurality of spatial streams in a transmitted signal. Accordingly, one type of beamforming that may be utilized in various embodiments involves transmitting the same signal from each BS antenna, e.g., antennas 132a . . . 132n of FIG. 1, but with a different amplitude and phase for each subcarrier and antenna. Thus, more signal power may be delivered to a UE. It should be noted that other types of beamforming may be utilized in accordance with various embodiments, e.g., single-user and multi-user beamforming. However, most types of beamforming rely on some form of adapting the per-antenna/per-subcarrier transmissions based on an instantaneous propagation channel in order to improve communication performance to one or more UEs.

As also described above, and although the physical propagation channel may be identical in both directions, i.e., the DL and UL channels, the effective BS to UE DL channel may not be the same as the effective UE to BS UL channel, because the respective circuitry at the BS and the UE may often be different. Therefore, and in accordance with various embodiments, the systems and methods of calibration described herein allow a BS to determine the discrepancy/difference/delta between effective UL and DL channels, and to determine a compensation matrix. It should be noted that in general, UL CSI may be obtained/determined. Accordingly, the compensation matrix in accordance with various embodiments, may be applied to the UL channel estimate from any UE in order to arrive at a sufficiently accurate approximation of a DL CSI estimate to that same UE.

To obtain the sufficiently accurate approximation of the DL CSI estimate, a calibration device that may be utilized in conjunction with a BS is provided in accordance with various embodiments. The calibration device may be dedicated to communicating with a BS to generate a reciprocity compensation matrix. In accordance with various embodiments, the calibration device may be a hardware element, device, or component having radio functionality, such as, e.g., the wireless transceiver station 102 of FIG. 1, but without the additional capabilities of, e.g., a fully functional UE, such as a cellular telephone. That is, the calibration device may be configured to communicate with a BS solely for the purpose of estimating an overall baseband-to-baseband channel response matrix, and conveying that estimated overall baseband-to-baseband channel response matrix to the BS.

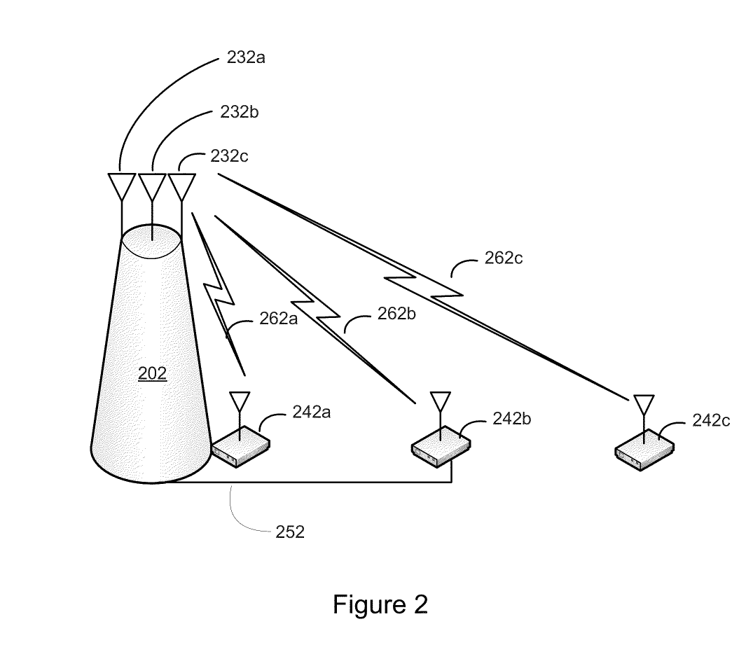

FIG. 2 illustrates example instantiations of a calibration device utilized in accordance with various embodiments of the present disclosure. In FIG. 2, a BS 202 is shown having a plurality of antennas 232a, 232b, and 232c. It should be noted that the BS 202 may be an NB, an eNB, an AP, etc. depending on the type of wireless communications systems/standards/protocols being considered, where the BS 202 may be an embodiment of the station 102 of FIG. 1. It should be further noted that the BS 202 is shown as having three antennas 232a, 232b, and 232c for ease of illustration and describing various embodiments, but is not limited to any number of antennas. In fact, and as will be described in greater detail below, various embodiments of the present disclosure are especially relevant for “massive” MIMO systems, where a hundred or more antennas may be utilized.

In accordance with one embodiment, the calibration device, i.e., calibration device 242a, may be a hardware device that can be implemented at or within the BS 202 itself The calibration device 242a may also be co-located with the BS 202, e.g., at a cell tower, or similar structure/facility. It should be noted that the calibration device 242a may also be implemented on the same IC chip or logic board as that of the BS 202, although certain design considerations may come into effect in order to integrate both the calibration device 242a and the BS 202 on the same IC chip/logic board. In accordance with another embodiment, the calibration device, i.e., calibration device 242b, may have a wired connection to the BS 202. In accordance with yet another embodiment, the calibration device, i.e., calibration device 242c, may be remotely located from, and wirelessly connect to the BS 202. With respect to location, calibration devices 242b and 242c need only be located close enough to the BS 202 to enable the transmission and receipt of reference symbols to and from the BS 202, and of conveying an estimated overall baseband-to-baseband DL channel response matrix to the BS 202.

Whether the calibration device is directly connected to the BS 202, such as calibration device 242a, has a wired connection to the BS 202, such as calibration device 242b, or wirelessly connects to the BS 202, such as calibration device 242c, the calibration device, as described above, may be configured to have radio functionality to make transmissions to and receive transmissions from the BS 202 for estimating an overall baseband-to-baseband UL channel response matrix. Such transmission and receipt may occur between at least one of the calibration devices 242a, 242b, and 242c, over an appropriate wireless transmission medium, e.g. one of wireless transmission mediums 262a, 262b, or 262c, respectively.

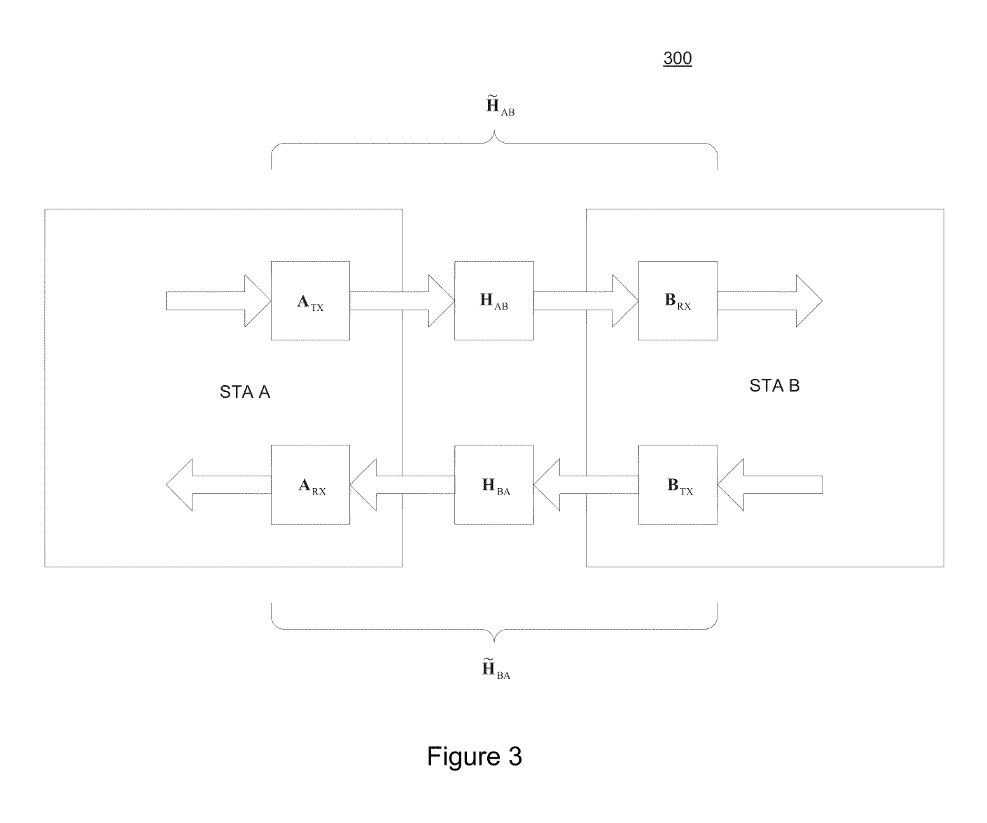

FIG. 3 illustrates an example system model 300 representative of baseband-to-baseband channel response as described previously. FIG. 3 illustrates a first station, STA A, which may be an embodiment of the wireless transceiver station 102 of FIG. 1, and may be representative of a BS. A second station, STA B may also be an embodiment of the wireless transceiver station 102 of FIG. 1, and may be representative of a calibration device in accordance with various embodiments. As further shown in FIG. 3, H_{AB} may refer to the over-the-air (OTA)/physical DL channel response matrix, and H_{BA} may refer to the OTA/physical UL channel response matrix. A_{TX}, A_{RX}, B_{RX} and B_{TX} may be complex diagonal matrices that can represent the amplitude and phase responses of the respective transmit and receive radio chains. \tilde{H}_{AB} and \tilde{H}_{BA} can refer to the overall baseband-to-baseband channel response matrices for the aforementioned effective DL and UL channels, respectively. Accordingly, \tilde{H}_{AB} and \tilde{H}_{BA} may be thought of as follows:

\tilde{H}H_{AB}=B_{RX} H_{AB} A_{TX}

\tilde{H}_{BA}=A_{RX} H_{BA} B_{TX}

Again, A_{TX}, A_{RX}B_{RX} and B_{TX} being indicative of the transmit and receive radio chains which can include the differing digital and analog circuitry of the transmitter and receiver, may be representative of RF-introduced mismatches, effectively resulting in \tilde{H}_{AB}≠H_{BA}^{T}.

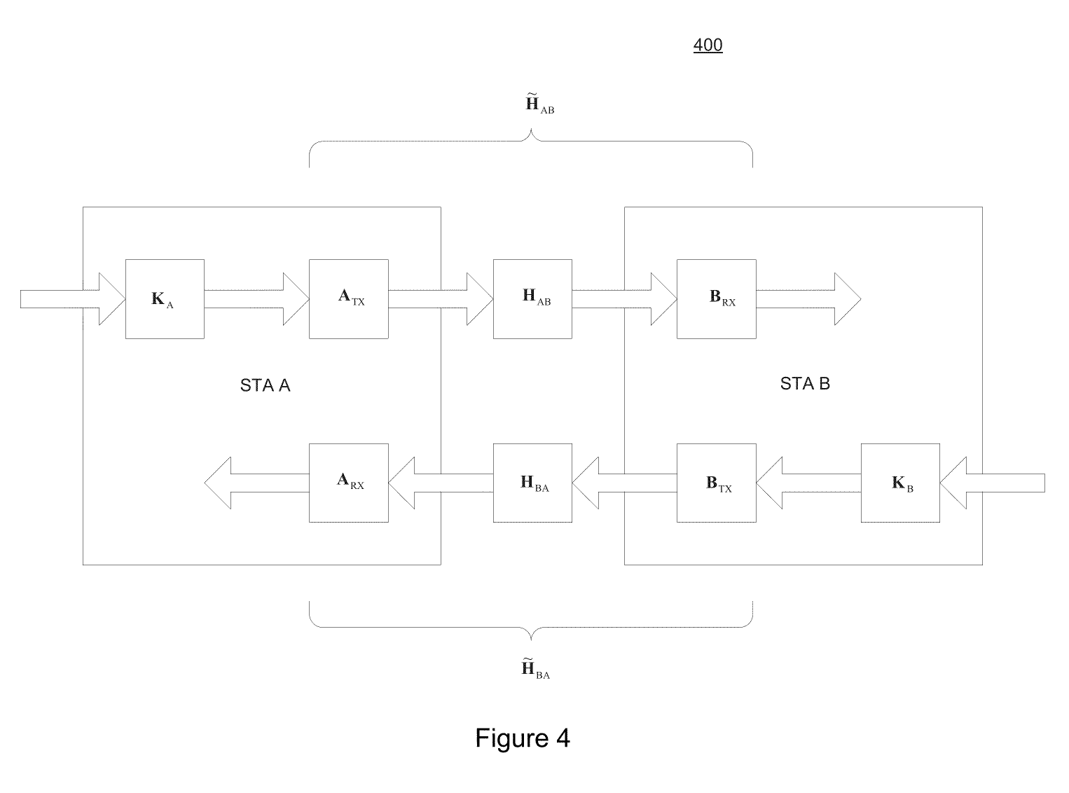

FIG. 4 illustrates an example reciprocity compensation model 400 representative of the introduction of compensation matrices such that the physical OTA channel response is reciprocal, i.e., \tilde{H}_{AB}=H_{BA}^{T}. Similar to the system model 300 of FIG. 3, reciprocity compensation model 400 may have a first station, STA A, which may be an embodiment of the wireless transceiver station 102 of FIG. 1, and may be representative of a BS. A second station, STA B may also be an embodiment of the wireless transceiver station 102 of FIG. 1, and may be representative of a calibration device in accordance with various embodiments. As further shown in FIG. 4, H_{AB} may refer to the over-the-air/physical DL channel response matrix, and H_{BA} may refer to the over-the-air/physical UL channel response matrix. A_{TX}, A_{RX}, B_{RX}, and B_{TX} may be complex diagonal matrices that can represent the amplitude and phase responses of the transmit and receive radio chains. \tilde{H}_{AB} and \tilde{H}_{BA} can refer to the overall baseband-to-baseband channel response matrices for the aforementioned effective DL and UL channels, respectively. Accordingly, \tilde{H}_{AB} and \tilde{H}_{BA} may be thought of as follows:

\tilde{H}_{AB}=B_{RX} H_{AB} A_{TX} K_{A}

\tilde{H}_{BA}=A_{RX} H_{BA} B_{TX} K_{B}

Again, A_{TX}, A_{RX}, B_{RX}, and B_{TX} being indicative of the transmit and receive radio chains which can include the differing digital and analog circuitry of the transmitter and receiver, may be representative of RF-introduced mismatches. Therefore, and again, the amplitude and phase responses of the transmit and receive radio chains may not be equal. For example, A_{TX}≠A_{RX} and B_{TX}.≠B_{RX}. Accordingly, reciprocity compensation may be applied such that \tilde{H}_{AB}=H_{BA}^{T}. Thus, at STA A, K_{A}=A_{TX}⁻A_{RX}, and at STA B, K_{B}=B_{TX}⁻¹B_{RX}., where compensation matrices K_{A} and K_{B} may be complex diagonal matrices.

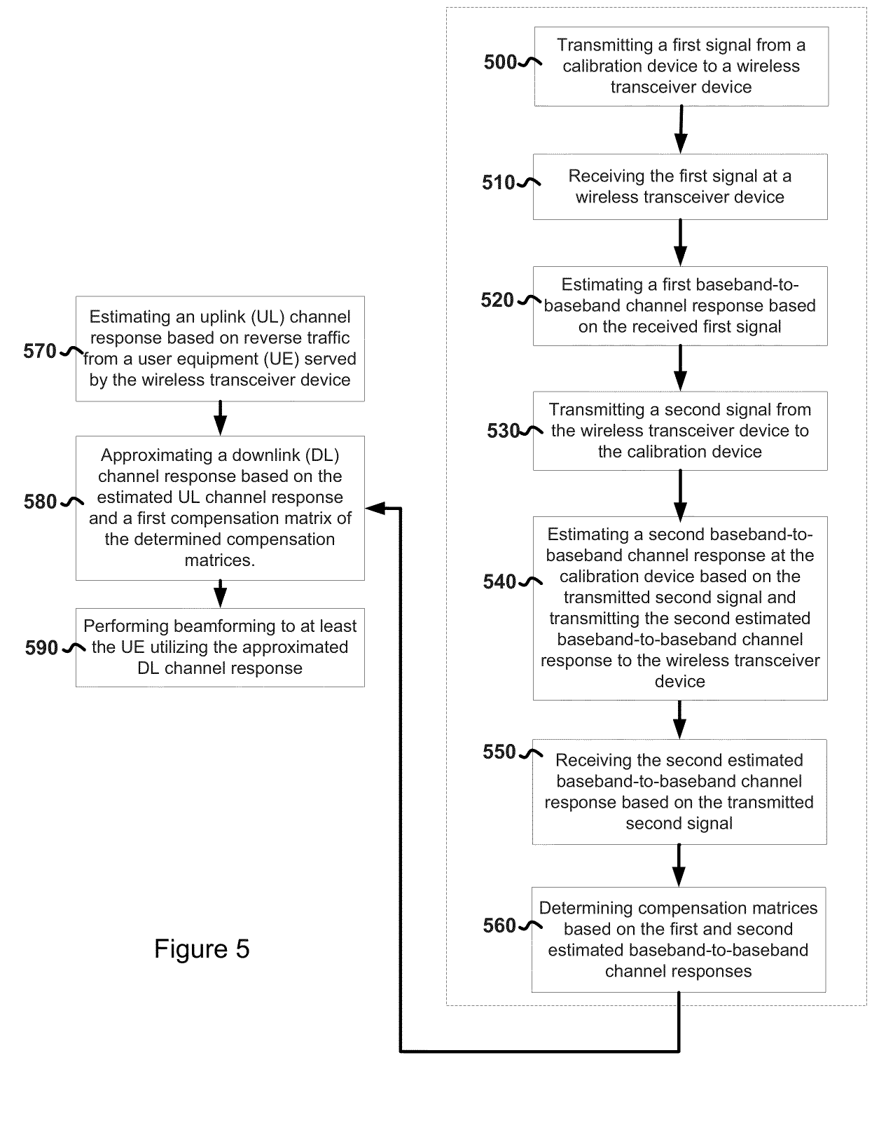

FIG. 5 is a flow chart illustrating example processes that may be executed to perform a calibration process in accordance with various embodiments. A first signal may be transmitted from a calibration device to a wireless transceiver device (500). The wireless transceiver device, such as a BS, may receive the first signal (510). As described above, the calibration device may be connected to the BS, wired to the BS, or remotely located from the BS. The calibration device can be triggered by the BS, e.g., instructing the calibration device to transmit the first signal, for example, during/at or subsequent to power up of the BS (whether power up occurs the first time the BS is being utilized, or after, e.g., a reset, etc.) Additionally, and although in many scenarios, the calibration may be considered static and thus sufficient to perform one time, the BS may re-trigger the calibration device to transmit the first signal if one or more external conditions arise that may affect performance of the BS, such as, e.g. the occurrence of a significant temperature differential at the BS. It should be noted that it may be preferable to trigger the calibration device at a time when no other communications involving the BS are occurring or halt such communications to avoid interfering with the first signal.

The wireless transceiver device may estimate a first baseband-to-baseband channel response (520). As discussed above, such a baseband-to-baseband channel response can be represented by the matrix \tilde{H}_{BA} (indicative of the effective baseband-to-baseband UL channel response between the calibration device and the BS which may include the disparate amplitude and phase responses of the transmit and receive radio chains at the calibration device and BS, respectively). A second signal may be transmitted from the BS to the calibration device (530). The calibration device may estimate a baseband-to-baseband channel response that can be represented by the matrix \tilde{H}_{AB} (indicative of the effective baseband-to-baseband DL channel response between the calibration device and the BS which may include the disparate amplitude and phase responses of the transmit and receive radio chains at the BS and calibration device, respectively), and transmit that estimated second baseband-to-baseband channel response to the BS (540). The BS may receive the second estimated baseband-to-baseband channel response based on the transmitted second signal (550). The BS may determine compensation matrices (e.g., K_{A} and K_{B}) based on the first and second estimated OTA channel responses (560).

An UL channel response based on reverse traffic from a UE served by the BS (e.g., UL sounding pilots or normal UL traffic) may be estimated by the BS (570). That is, the BS may estimate \tilde{H}_{BA}, which in this instance, may be indicative of the effective baseband-to-baseband UL channel response between any actual UE being served by the BS and the BS which may include the disparate amplitude and phase responses of the transmit and receive radio chains at the UE and BS, respectively. \tilde{H}_{BA} may be estimated from UL sounding pilots or from normal data transmission, e.g., in WLAN. The BS may approximate an DL channel response based on a first compensation matrix of the determined compensation matrices (580). That is, the BS may utilize K_{A}, the compensation matrix of the amplitude and phase response of the transmit and receive radio chains of the BS, to approximate \tilde{H}_{AB} (indicative of the effective baseband-to-baseband DL channel response between the UE and the BS which may include the disparate amplitude and phase responses of the transmit and receive radio chains at the BS and UE, respectively) as follows.

(\tilde{H}_{AB})ₐₚₚᵣₒₓ=(\tilde{H}BA)^{T}K_{A}

Having approximated the OTA DL channel response, the BS can perform beamforming (to the actual UE or any UE being served by the BS for that matter) utilizing the approximated DL channel response (590).

It should be noted that the first and second signals received and transmitted by the BS may be a transmission having a known bit configuration, e.g., a constant-length sequence of consecutive bits, referred to as a training sequence. For example, the first and second signals may have multiple copies of the same sequence, and in accordance with certain embodiments, the training sequence may be longer to get a better noise average. Alternatively, and in accordance with certain other embodiments, the receipt and transmission of the first and second signals may simply be repeated for some period of time, and again, averaged.

It should be further noted that various methods and/or algorithms may be utilized to determine the compensation matrices. One example calibration algorithm that may be used in accordance with various embodiments is presented below using the following notations.
K_{A}=diag([k_{a,1}, k_{a,2}, . . . , k_{a,N}_{_{A}}]), where N_{A} is the number of active antennas at STA A
K_{B}=diag([k_{b,1}, k_{b,2}, . . . , k_{b,N}_{_{B}}]), where N_{B} is the number of active antennas at STA B
A_{TX}=diag([a_{T,1}, a_{T,2}, . . . , a_{T,N}_{_{A}}]), A_{RX}=diag([a_{R,1}, a_{R,2}, . . . , a_{R,N}_{_{A}}]);
B_{TX}=diag([b_{T1,}, b_{T,2}, . . . , b_{T,N}_{_{B}}]), B_{RX}=diag([b_{R,1}, b_{R,2}, . . . , b_{R,N}_{_{B}}]);

A difference matrix may be formed as follows.

$$D = {[ {\tilde{H}}_{BA} ]}^{T} \cdot \text{/} {\tilde{H}}_{AB} = {[ \frac{{\tilde{H}}_{BA} [ j , i ]}{{\tilde{H}}_{AB} [ i , j ]} ]}_{i , j} = {[ {d}_{i , j} ]}_{i , j}$$

The following may be considered to be true, where “∠” can refer to the angle of a complex number

$${d}_{i , j} = \frac{{a}_{R , j} \text{/} {a}_{T , j}}{{b}_{T , i} \text{/} {b}_{T , i}} = \frac{{k}_{a , j}}{{k}_{b , i}} \\ ⇒ log \vert {k}_{a , j} \vert - log \vert {k}_{b , i} \vert = log \vert {d}_{i , j} \vert = log \vert {\tilde{H}}_{BA} [ j , i ] \vert - log \vert {\tilde{H}}_{AB} [ i , j ] \vert ;$$

$$∠ {k}_{a , j} - ∠ {k}_{b , i} = ∠ {d}_{i , j} = ∠ {\tilde{H}}_{BA} [ j , i ] - ∠ {\tilde{H}}_{AB} [ i , j ]$$

In the log and angular domains, the following least-squares problem can be formulated, where “vec” can refer to a transformation to change a matrix into a long column vector (e.g., the first column of the matrix is first, followed by the second column of the matrix, and so on until the last column is transformed).

$$A [ \begin{matrix}log \vert {k}_{a , 1} \vert \\ ⋮ \\ log \vert {k}_{a , {N}_{A}} \vert \\ log \vert {k}_{b , 1} \vert \\ ⋮ \\ log \vert {k}_{b , {N}_{B}} \vert\end{matrix} ] = vec ( {[ log \vert {d}_{i , j} \vert ]}_{i , j} ) ;$$

$$A [ \begin{matrix}∠ {k}_{a , 1} \\ ⋮ \\ ∠log {k}_{a , {N}_{A}} \\ ∠log {k}_{b , 1} \\ ⋮ \\ ∠log {k}_{b , {N}_{B}}\end{matrix} ] = vec ( {[ ∠ {d}_{i , j} ]}_{i , j} ) ;$$

where

A=[I_{N}_{_{A}} [symbol] 1_{N}_{_{B}}|−1_{N}_{_{B}} [symbol] I_{N}_{_{A}}] and [symbol] represents kronecker product

In a special case of 3×3, the following matrix may be used.

$$A = [ \begin{matrix}1 & 0 & 0 & - 1 & 0 & 0 \\ 1 & 0 & 0 & 0 & - 1 & 0 \\ 1 & 0 & 0 & 0 & 0 & - 1 \\ 0 & 1 & 0 & - 1 & 0 & 0 \\ 0 & 1 & 0 & 0 & - 1 & 0 \\ 0 & 1 & 0 & 0 & 0 & - 1 \\ 0 & 0 & 1 & - 1 & 0 & 0 \\ 0 & 0 & 1 & 0 & - 1 & 0 \\ 0 & 0 & 1 & 0 & 0 & - 1\end{matrix} ]$$

A final compensation matrix may be given by the following, where “pinv” can refer to a pseudo inverse operation.

$$[ \begin{matrix}log \vert {k}_{a , 1} \vert \\ ⋮ \\ log \vert {k}_{a , {N}_{A}} \vert \\ log \vert {k}_{b , 1} \vert \\ ⋮ \\ log \vert {k}_{b , {N}_{B}} \vert\end{matrix} ] = pin v ( A ) vec ( {[ log \vert {d}_{i , j} \vert ]}_{i , j} ) , \\ [ \begin{matrix}∠ {k}_{a , 1} \\ ⋮ \\ ∠ log {k}_{a , {N}_{A}} \\ ∠ log {k}_{b , 1} \\ ⋮ \\ ∠ log {k}_{b , {N}_{B}}\end{matrix} ] = pin v ( A ) vec ( {[ ∠ {d}_{i , j} ]}_{i , j} ) .$$

It should be noted that in accordance with various embodiments, the calibration process described above, as well as the use of compensation matrices determined by the calibration process, may be applicable at a per-frequency/per-frequency band level. Accordingly, calibration and DL beamforming (as will be discussed further below) in accordance with various embodiments, can be flexible and scaled to various types/sizes of systems. This may be contrasted with conventional calibration methods that are limited to a per-antenna/per-UE level, making calibration in, e.g., massive MIMO systems unfeasible, or at the least, difficult to achieve.

Moreover, only one of the compensation matrices, i.e., K_{A}, needs to be utilized when approximating the OTA DL channel response, while the other compensation matrix, K_{B} may be ignored without significantly impacting beamforming performance in most instances. Even if, e.g., there is some impact to beamforming performance, the penalty may be negligible. Moreover, the compensation matrix, K_{A}, obtained from performing calibration in accordance with various embodiments may be utilized to perform beamforming for “any” UE. Hence, and as described previously, the BS need only perform calibration once in most instances.

This again is in contrast to more conventional methods of “2-way” calibration, where both the OTA UL and DL channel responses are utilized. Relying on only one of the compensation matrices can result in less time spent performing calibration, and may also avoid scenarios where an actual UEs that may be utilized for calibration purposes is not be available to complete the 2-way calibration. Additionally, and by utilizing a dedicated calibration device in accordance with various embodiments as described herein, the calibration device may remain under the control of the BS, which may not necessarily be the case when calibrating using actual UEs. Additionally still, and as described above, conventional calibration methods may be at the per-UE level, and one-time/one-way calibration may not suffice.

As alluded to previously paired spectrum is becoming a scarce commodity in the wireless communication space, and therefore, dynamic TDD UL-DL configuration for traffic and interference adaption has been identified as being one the key enhancement techniques for future LTE iterations. Another key enhancement technique, massive MIMO, as described above, may require significant overhead for training unless done in TDD, i.e., exploiting channel reciprocity. Accordingly, the use of TDD and channel reciprocity may depend on accurate transmit/receive calibration, which may be achieved in accordance with various embodiments as described above.

It should be noted that various embodiments of the present disclosure are described in the context of TDD systems. However, the concepts described herein may also be applied to other types of wireless communication systems, such as FDD systems. Furthermore, calibration may be generally frequency band-independent. Accordingly, antennas and transmit-receive radio chains may be calibrated in accordance with various embodiments for a first standard/band, and the values obtained/determined therefrom, may be applied to a second standard/band. For example, and in accordance with other embodiments, calibration may be performed on a WLAN band, but utilized for beamforming on a LTE system. Further still, and if a device has multiple antennas, only a single antenna may be required for use. That is, the DL channel may be quantized to a single antenna, and uplink sounding pilots may be transmitted from that same single antenna.

The various diagrams illustrating various embodiments may depict an example architectural or other configuration for the various embodiments, which is done to aid in understanding the features and functionality that can be included in those embodiments. The present disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement various embodiments. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and/or functionality described in one or more of the individual embodiments are not limited in their applicability to the particular embodiment with which they are described, but instead can be applied, alone or in various combinations, to one or more of the other embodiments, whether or not such embodiments are described and whether or not such features, aspects and/or functionality is presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in, e.g., a non-transitory computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

As used herein, the term module can describe a given unit of functionality that can be performed in accordance with one or more embodiments. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. Where components or modules of the invention are implemented in whole or in part using software, in one embodiment, these software elements can be implemented to operate with a computing or processing module capable of carrying out the functionality described with respect thereto. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
receiving a first signal, from a calibration device, at a wireless transceiver device;
estimating a first baseband-to-baseband channel response based on the received first signal;
transmitting, to the calibration device, a second signal from the wireless transceiver device;
receiving a second estimated baseband-to-baseband channel response, from the calibration device, based on the transmitted second signal;
determining compensation matrices based on the first and second estimated baseband-to-baseband channel responses;
estimating an uplink (UL) channel response;
approximating a downlink (DL) channel response based on a first compensation matrix of the determined compensation matrices; and
performing beamforming utilizing the approximated DL channel response.

2. The method of claim 1, wherein the wireless transceiver device comprises a base station.

3. The method of claim 1, wherein the second estimated baseband-to-baseband channel response is determined at the calibration device.

4. The method of claim 3, wherein the calibration device is dedicated solely to engaging in calibration procedures with the wireless transceiver device.

5. The method of claim 3, wherein the calibration device is one of physically attached to the wireless transceiver device, remotely connected via a wired connection to the wireless transceiver device, or remotely located and wirelessly connected to the wireless transceiver device.

6. The method of claim 1, wherein the estimating of the UL channel response occurs between the wireless transceiver device and a user equipment (UE) operative in a service area served by the wireless transceiver device.

7. The method of claim 1, wherein the first compensation matrix comprises a complex diagonal matrix based on amplitude and phase responses of a transmit and receive radio chain within the wireless transceiver device.

8. The method of claim 1, wherein the determined compensation matrices comprises the first compensation matrix and a second compensation matrix

9. The method of claim 8, wherein the second compensation matrix comprises a complex diagonal matrix based on amplitude and phase responses of a transmit and receive radio chain within a calibration device.

10. The method of claim 8 further comprising, ignoring the second compensation matrix of the determined compensation matrices.

11. The method of claim 1, wherein the receipt of the first signal occurs in response to a triggering instruction sent by the wireless transceiver device to the calibration device to transmit the first signal during or subsequent to power up of the wireless transceiver device.

12. The method of claim 11, wherein the transmission of the first signal from the calibration device and the transmission of the second signal from the wireless transceiver device comprises a training sequence.

13. The method of claim 12 further comprising, at least one of elongating the training sequence and repeating the training sequence to obtain a noise average.

14. The method of claim 1, wherein the estimating of the first and second baseband-to-baseband channel responses occurs on either the same frequency band or a different frequency band upon which the performance of the beamforming occurs.

15. A computer program product, embodied on a non-transitory computer-readable medium, comprising:
computer code for estimating an uplink (UL) channel response;
computer code for approximating a downlink (DL) channel response based on the estimated UL channel response and a compensation matrix associated with a transmit and receive radio chain of a wireless transceiver device; and
computer code for performing beamforming from the wireless transceiver device utilizing the approximated DL channel response.

16. The computer program product of claim 15 further comprising, computer code for receiving one of UL sounding pilot signals or normal data transmission from a user equipment (UE) to allow the computer code for estimating the UL channel response to perform the estimating of the UL channel response.

17. The computer program product of claim 16, wherein the compensation matrix comprises a complex diagonal matrix based on amplitude and phase responses of the transmit and receive radio chain within the wireless transceiver device.

18. The computer program product of claim 15 further comprising, computer code for determining the compensation matrix during a calibration procedure involving the wireless transceiver device and a dedicated calibration device.

19. A system, comprising:
a wireless transceiver device for:
receiving a first training sequence signal;
estimating a first baseband-to-baseband channel response based on the first training sequence signal; and
transmitting a second training sequence signal;
a calibration device for:
transmitting the first training sequence signal to the wireless transceiver device;
receiving the second training sequence signal from the wireless transceiver device; and
estimating a second baseband-to-baseband channel response based on the second training sequence signal, and conveying the second baseband-to-baseband channel response to the wireless transceiver device; and
a user equipment (UE) for:
transmitting one of UL sounding pilot signals and normal data to the wireless transceiver device, wherein
the wireless transceiver device further determines compensation matrices based on the first and second estimated baseband-to-baseband channel responses, estimates an uplink (UL) channel response based on the one of the UL sounding pilot signals and the normal data, approximates a downlink (DL) channel response based on a first compensation matrix of the determined compensation matrices, and performs beamforming to the UE utilizing the approximated DL channel response.

20. The system of claim 19, wherein the calibration device is one of physically attached to the wireless transceiver device, remotely connected via a wired connection to the wireless transceiver device, or remotely located and wirelessly connected to the wireless transceiver device.
